(19) United States
(12) Patent Application Publication
(10) Pub. No.: US 2007/0091641 A1
(43) Pub. Date: Apr. 26, 2007

(54) Backlight structure

(75) Inventors: Ming-Te Lin, Hsinchu Hsien (TW); Sheng-Pan Huang, Hsinchu (TW); Shang-Ping Ying, Hsinchu (TW); Ya-Hui Chiang, Hsinchu (TW); Ming-Yao Lin, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu (TW)

(21) Appl. No.: 11/583,944

(22) Filed: Oct. 20, 2006

(30) Foreign Application Priority Data
Sep. 21, 2006 (TW) 095134928
Oct. 20, 2005 (TW) 094136658

(51) Int. Cl. F21V 7/04

(52) U.S. Cl. 362/615

(57) ABSTRACT

A backlight structure is disclosed, which is constituted of a series of backlight devices connecting with one another to form a large-scale backlight area, the backlight device at least being composed of an emitting portion and a light-guiding portion, wherein the emitting portion provides a light source, mixes the light of the light source and provides the mixed light into the light-guiding portion, which then guides the mixed light out. The emitting portion connects with the light-guiding portion to form a fault structure for connecting with another light-guiding portion, thereby forming a large-scale backlight structure by connecting a sequence of the light-guiding portions using the fault structures without size constraints.

### FIELD OF THE INVENTION

The present invention relates to backlight structures, and more particularly, to sequential backlight structures.

### BACKGROUND OF THE INVENTION

With the development of light-emitting diodes (LEDs) technology, the luminance of the LEDs has greatly improved. Accordingly, application of LEDs in backlight modules increases. Currently, LED backlight modules are widely used in various related fields such as mobile phones, cars, displays, TVs, etc.

Since LED backlight modules are characterized by various advantageous such as high definition, high brightness, non mercury and high-color reproduction. Thus, the LED backlight modules are different from traditional Cathode Ray Tube (CRT) modules in terms of appearance, optical properties, luminance intensity and design. The designs of LED backlight modules can be distinguished according to their packaging types, and can be generally classified into two types: direct type and edge type. Direct-type LED backlight modules comprise a plurality of LEDs arranged into a module, which is then directly disposed underneath a LCD related component (e.g. a LCD panel or an optical film). Although the direct-type LED backlight modules have a higher light transmission, but they require a longer diffusion distance and more complicated optical design to overcome unevenness in light intensity and color occurred when light from the LEDs of the backlight module is irradiated to a LCD panel. Thus, under the considerations of thinner and lighter flat-panel TVs, edge-type LED backlight modules are currently the main focus of development.

Referring to FIG. 3, a traditional edge-type LED backlight module is shown. As shown, the edge-type LED backlight module 30 comprises a LED emitter 31, a first reflective device 32, a light-mixing device 33, a second reflective device 34 and a light-guiding plate 35. The LED emitter 31 comprises a plurality of repeatedly arranged LEDs. A light source provided by the LED emitter 31 is reflected by the first reflective device 32, and then uniformly distributed by the light-mixing device 33 to the second reflective device 34, which allows light to be reflected by 180°. Thereafter, the evenly distributed light is directed to the light-guiding plate 35. Since the edge-type LED backlight module allows light to be mixed by the light-mixing device 33 from a long distance, the effect of light mixing is better. Also, a thinner module can be provided compared to a direct-type backlight module. However, as the size of the edge-type LED backlight module 30 increases, light intensity directed into the light-guiding plate 35 gradually decreases, such that the luminance of the backlight guided by the light-guiding plate 30 to the LCD panel may be insufficient. Although the light intensity can be raised by increasing the number of LEDs or providing larger operating power of the LEDs, but the problem of uneven or insufficient light intensity due to gradual decrease of the light intensity in the light-guiding plate 35 still exists. Thus, the edge-type LED backlight module 30 is not suitable for large-scale backlight modules.

### SUMMARY OF THE INVENTION

In the light of forgoing drawbacks, a main objective of the present invention is to provide a backlight structure to improve problems such as uneven light source and poor light mixing.

Another objective of the present invention is to provide a backlight structure with integrally formed light-mixing structure and reflection structure to reduce errors in assembly of the relevant components.

Still another objective of the present invention is to provide a backlight structure that can be formed as a large-scale backlight structure by sequentially connecting backlight devices.

Yet another objective of the present invention is to provide a backlight structure that overcomes the problem of uneven distribution of intensity when used in large scale.

In accordance with the above and other objectives, the present invention provides a backlight structure, comprising a plurality of backlight devices that are sequentially connected to form a large-scale backlight area. Each of the backlight devices comprises an emitting portion and a light-guiding portion. The light-guiding portion has an oblique shape, a light-guiding face connected with the emitting portion, a first face, a second face opposite to the first face and a light output face opposite to the light-guiding face. The emitting portion can be used to provide a LED light source and mix the light source. The light-guiding portion can be used to then uniformly guide the light mixed by the emitting portion. The second face and the emitting portion can be connected to form a stepped fault structure, which abuts the first face of another backlight device, that is, the sections joining the emitting portions and the light-guiding portions can be sequentially connected through the fault structures to form a large-scale backlight structure.

Furthermore, the present invention provides a backlight structure. The differences between this backlight structure and the above backlight structure are mainly that the backlight device comprises an emitting portion, a reflection portion and a light-guiding portion. An LED light source can be provided by the emitting portion, mixed by an extending portion of the reflection portion, and reflected by the reflection portion to the light-guiding portion to be uniformly guided out. The above reflection portion and the light-guiding portion can be integrally formed as one structure and have the same transmittance. The light emitted by the emitting portion is reflected and guided into the light-guiding portion by the reflection portion, in which the reflection portion can be plated with a reflective layer to increase reflectivity. The reflection portion connects with the second face of the light-guiding portion to form a fault structure, which abuts to the first face of another backlight device, that is, the sections joining the reflection portions and the light-guiding portions can be sequentially connected through the fault structures to form a large-scale backlight structure.

In addition, the present invention provides a backlight structure assembly, in which the first faces of above two backlight structures are connected back to back to form a large-scale backlight area. The first face of any one of the two backlight structures is not connected to the fault structure formed by connecting the second face and the reflection face of the other backlight structure. In other words, the first face at the shorter side of the oblique face of one light-guiding portion is connected to the first face at the shorter side of the oblique face of the other light-guiding portion, so the backlight devices are sequentially connected to form a large-scale backlight area without size constraint.

Since the backlight structure is an edge-type backlight structure, when a large-scale backlight structure is formed by sequential connection of the backlight devices, light can be mixed by the emitting portion to increase its light-mixing effect. Furthermore, the section joining the second face of the light-guiding portion of a backlight device and the first face of the light-guiding portion of another backlight device can be removed to form a passage, such that light generated by one backlight device can propagate to another through this passage and vice versa, so as to achieve a better uniformity.

Moreover, since the backlight structure comprises at least one fault structure, one backlight device may closely connects to the light-guiding portion of another backlight device via the fault structure, thus, by virtue of the fault structures, the light-guiding portions can be sequentially connected together to form a large-scale backlight structure, so its size no longer limited. In other words, the backlight structure of the present invention can form various kinds of large-scale backlight sources by sequential connections, overcoming the problem of size constraint. Also, the backlight structure is an edge-type backlight structure, thus eliminating the problem of uneven distribution of the intensity when used in large scale; therefore, it can be applied to large-size TVs or relevant LED fields.

### BRIEF DESCRIPTION OF THE DRAWINGS

The present invention can be more fully understood by reading the following detailed description of the preferred embodiments, with reference made to the accompanying drawings, wherein:

FIGS. 1A and 1B are schematic diagrams depicting a first embodiment of a backlight structure of the present invention;

FIG. 1C is a schematic diagram of the first embodiment of a backlight structure assembly of the present invention;

FIGS. 2A and 2B are schematic diagrams depicting a second embodiment of the backlight structure of the present invention;

FIGS. 2C and 2D are schematic diagrams depicting a second embodiment of the backlight structure assembly of the present invention; and

FIG. 3 (PRIOR ART) is a schematic diagram showing a traditional edge-type LED backlight module.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

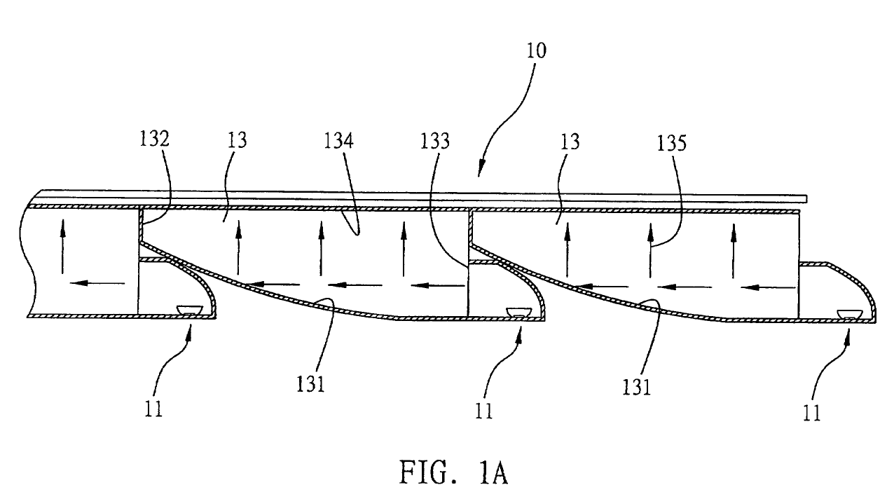

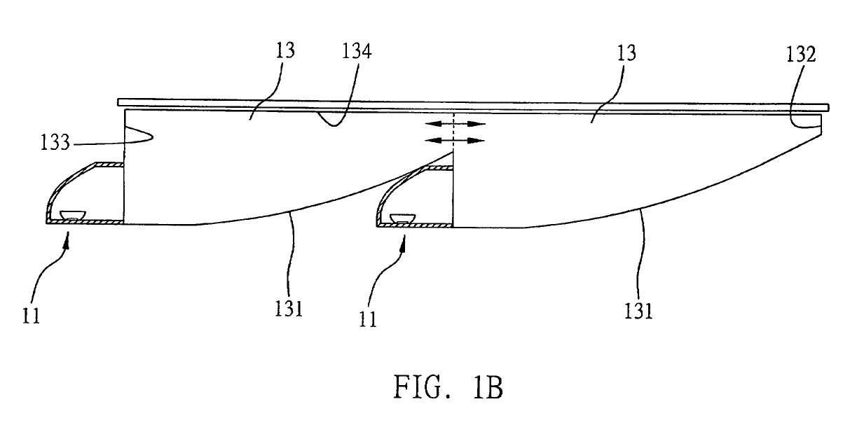

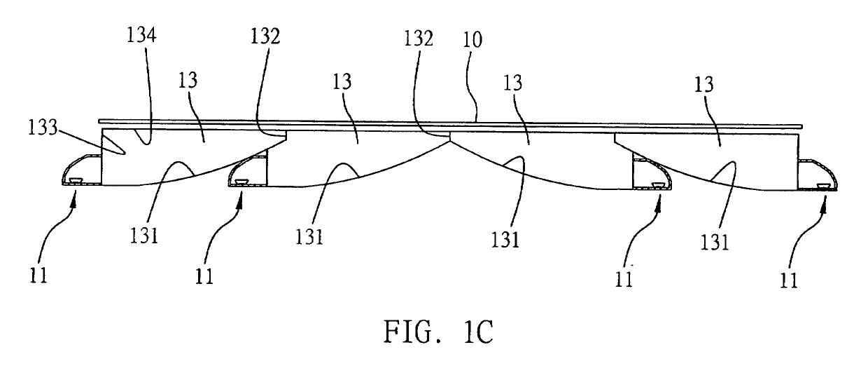

Referring to FIGS. 1A to 1D, schematic diagrams depicting a first embodiment of a backlight structure and assembly of the present invention are shown.

As shown in FIG. 1A, the backlight structure of the present invention is formed by a plurality of backlight devices 10 connected in sequence. Each backlight device 10 is at least consisted of an emitting portion 11 and a light-guiding portion 13. The emitting portion 11 may be a LED device for providing LED light source. The light-guiding portion 13 may be a light-guiding material that has an oblique face. The light-guiding portion 13 also comprises a light-guiding face 131 connected to the emitting portion 11, a first face 132, a second face 133 opposite to the first face 132 and a light output face 134 opposite to the light-guiding face 131. The light-guiding face 131 may be roughened to form a scattering structure, such that light mixed by the emitting portion 11 can be uniformly guided.

The light-guiding portion 13 and the emitting portion 11 are connected in such a way as to form a step-like fault structure, which abuts and connects the light-guiding portion 13 of another backlight device 10, that is, the fault structure abuts and connects to the first face 132 of another light-guiding portion 13. Thereby, using this fault structure, connected portions of the emitting portion 11 and the light-guiding portion 13 can be sequentially connected to form a large-scale backlight structure. Thus, when the large-scale backlight structure is formed by sequential connection, LED light source is mixed by the emitting portion 11 to increase its light-mixing effect and uniformly guided by the light-guiding portion 13 towards the light output face 134 in a light exit direction 135.

As shown in FIG. 1B, in this backlight structure, the section joining the second face 133 of the light-guiding portion 13 of a backlight device and the first face 132 of the light-guiding portion 13 of another backlight device is removed to form a passage, such that light generated by one backlight device can propagate to another through this passage and vice versa, so as to achieve a better uniformity.

As shown in FIG. 1C, in a backlight structure assembly of the present invention, two first faces 132 of two backlight structures are connected back to back, forming a large-scale backlight area. These first faces 132 are not connected to the second face 133 of any other backlight device 10, that is, the first face 132 at the shorter side of the oblique face of one light-guiding portion 13 is connected to the first face 132 at the shorter side of the oblique face of the other light-guiding portion 13, so the backlight devices are sequentially connected to form a large-scale backlight area.

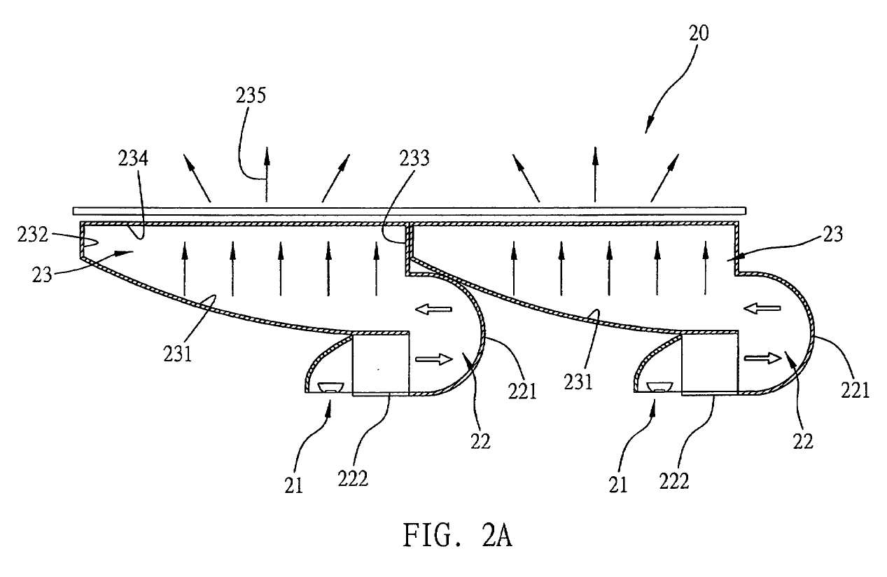

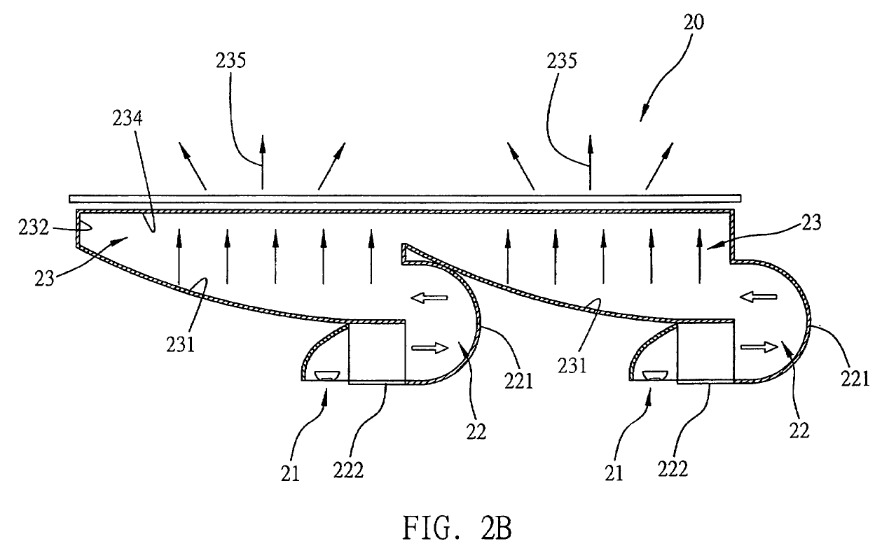

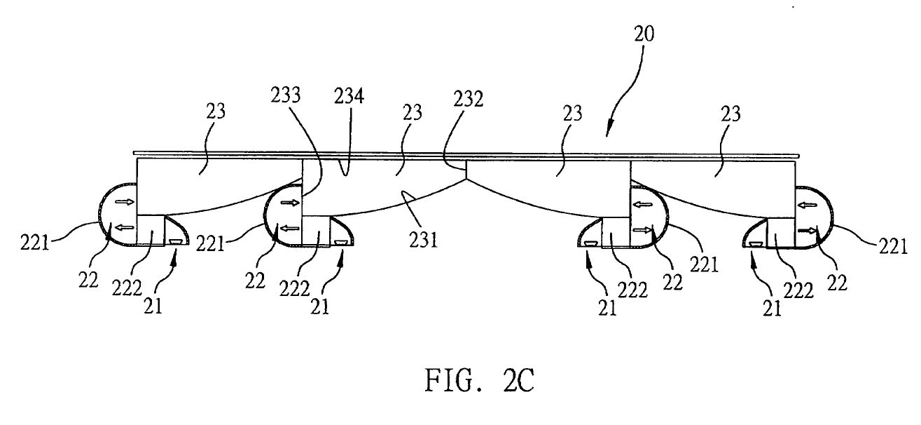

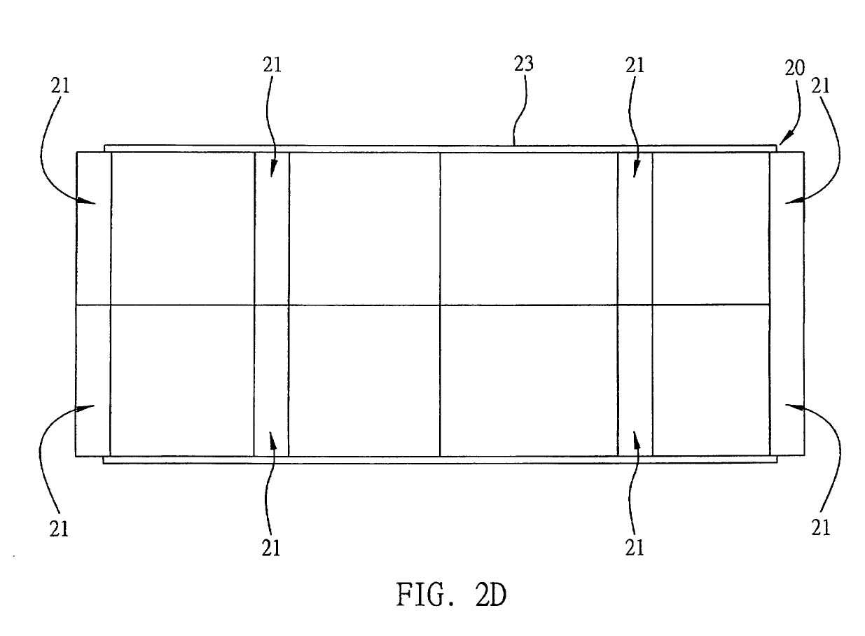

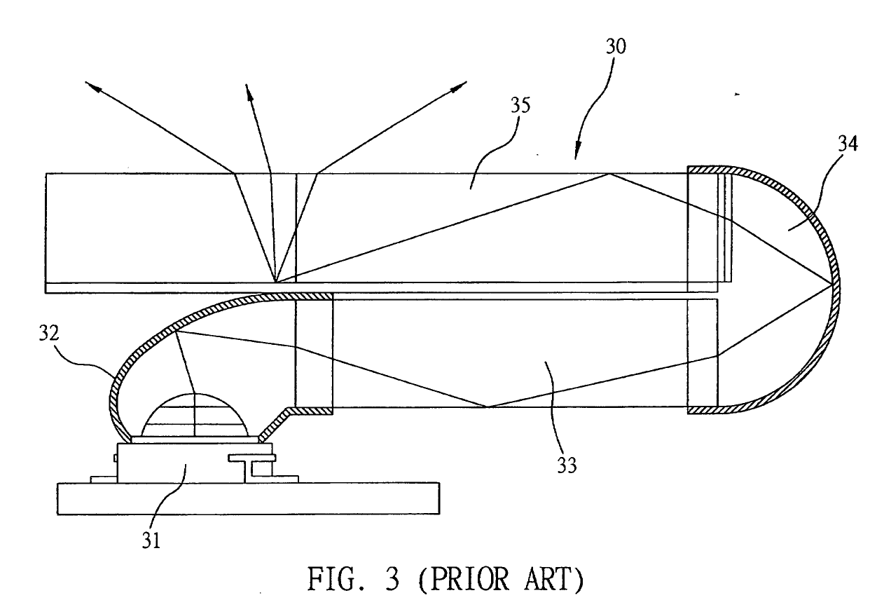

Referring to FIGS. 2A to 2D, schematic diagrams depicting a second embodiment of the present invention are shown.

The backlight device in this embodiment is similar to that in the first embodiment. However, the main difference is that the backlight device 20 is at least consisted of an emitting portion 21, a reflection portion 22 and a light-guiding portion 23. The reflection portion 22 and the emitting portion 21 are connected to form a step-like fault structure, which abuts the light-guiding portion 23 of the other backlight device 20, so as to form a large-scale backlight structure.

As shown in FIG. 2A, the backlight structure of the present invention is formed by sequentially connecting a plurality of backlight devices 20. Each backlight device 20 is at least consisted of an emitting portion 21, a reflection portion 22 and a light-guiding portion 23. The reflection portion 22 is connected with the light-guiding portion 23. The reflection portion further includes an extending portion 222 for mixing the light source provided by the emitting portion 21. The extending portion 222 includes a reflective face 221 for reflecting (e.g. by 180 degrees) the mixed light to the light-guiding portion 23. The light is then guided by the light-guiding portion 23 to the light output face 234 and uniformly outputted thereby. The reflection portion 22 and the second face 233 of the light-guiding portion 23 are connected to form the fault structure, which abuts and connects to the first face 232 of another light-guiding portion 23. That is, by this fault structure, the section joining the reflection portion 22 and the light-guiding portion 23 can be sequentially connected to form a large-scale backlight structure. Additionally, since the backlight structure is an edge-type backlight structure, when the large-scale backlight structure is formed by sequential connection of the backlight devices, light can be mixed by the extending portion 222 of the reflection portion 222 to increase its light-mixing effect and uniformly guided by the light-guiding portion 23 towards the light output face 234 in a light exit direction 235.

As shown in FIG. 2B, in this backlight structure, the section joining the second face 233 of the light-guiding portion 23 of a backlight device and the first face 232 of the light-guiding portion 23 of another backlight device is removed to form a passage, such that light generated by one backlight device can propagate to another through this passage and vice versa, so as to achieve a better uniformity.

As shown in FIG. 2C, in this backlight structure assembly of the present invention, two first faces 232 of two backlight structures are connected back to back, forming a large-scale backlight area. These first faces 232 are not connected to the second face 233 of any other backlight device 20, that is, the first face 232 at the shorter side of the oblique face of one light-guiding portion 23 is connected to the first face 232 at the shorter side of the oblique face of the other light-guiding portion 23, so the backlight devices are sequentially connected to form a large-scale backlight area.

As shown in FIG. 2D, a bottom view of a backlight structure of the present invention is shown. The abovementioned backlight structure can be composed of a plurality of backlight devices in a row. The backlight device 20 at least includes an emitting portion 21, a reflection portion 22 and a light-guiding portion 23. A large-scale backlight structure can be composed by sequentially connecting a plurality of backlight devices, so its size is no longer limited.

In summary, the backlight structure forms a large-scale backlight area by sequentially connecting a plurality of backlight devices. The backlight device is at least composed of an emitting portion and a light-guiding portion. A LED light source is generated and mixed by the emitting portion and guided into the light-guiding portion. A roughened light-guiding face of the light-guiding portion forming a scattering structure can uniformly guide the light mixed by the emitting portion 11 towards a light output face (e.g. a LCD panel) of the light-guiding portion, thus solving the problem of unevenness light source. In addition, since the backlight structure is an edge-type backlight structure, the light-mixing uniformity of the light may be increased after being mixed by the emitting portion.

Moreover, since the emitting portion and the light-guiding portion are connected in such a way as to form a fault structure (e.g. a step-like fault structure), one backlight device may closely connects to the light-guiding portion of another backlight device via the fault structure, that is, by virtue of the fault structure, the light-guiding portions can be sequentially connected together for use, so the size of the backlight structure is not limited. Furthermore, the section joining the second face of the light-guiding portion of a backlight device and the first face of the light-guiding portion of another backlight device can be removed to form a passage, such that light generated by one backlight device can propagate to another through this passage and vice versa, so as to achieve a better uniformity.

Additionally, the backlight structure of the present invention can form various kinds of large-scale backlight sources by sequential connections, overcoming the problem of size constraint. Also, the backlight structure is an edge-type backlight structure, thus eliminating the problem of uneven distribution of the intensity when used in large scale; therefore, it can be applied to large-size TVs or relevant LED fields.

The above embodiments are only used to illustrate the principles of the present invention, and they should not be construed as to limit the present invention in any way. The above embodiments can be modified by those with ordinary skills in the arts without departing from the scope of the present invention as defined in the following Appended claims.

1. A backlight structure comprising a plurality of backlight devices, each of the backlight devices comprising:
an emitting portion for providing a Light-Emitting Diode (LED) light source and mixing the light source; and
a light-guiding portion for guiding the light mixed by the emitting portion, the light guiding portion comprising a first face and a second face opposite to the first face, the second face and the emitting portion forming a fault structure.

2. The backlight structure of claim 1, wherein the fault structure formed by the second face and the emitting portion of at least one of the backlight devices is joined with the first face of another one of the backlight devices.

3. The backlight structure of claim 2, wherein the light-guiding portion is a light-guiding material with an oblique shape.

4. The backlight structure of claim 3, wherein a thickness of oblique shape decreases with an increase in incident distance of the light source.

5. The backlight structure of claim 2, wherein the fault structure is a stepped fault structure.

6. The backlight structure of claim 2, wherein the light-guiding portion comprises a light-guiding face connected with the emitting portion and a light output face opposite to the light-guiding face.

7. The backlight structure of claim 6, wherein a roughening process and a printing process are performed on the light-guiding face to form a scattering structure.

8. The backlight structure of claim 2, further comprising a passage formed by removing a section joining the second face of the light-guiding portion of one of the backlight devices and the first face of the light-guiding portion of another one of the backlight devices, such that light generated by the one of the backlight devices propagates to the another one of the backlight devices through this passage and vice versa.

9. A backlight structure assembly, comprising a plurality of the backlight structures of claim 2, the first faces of two backlight structures being connected back to back to form a large-scale backlight area, the first face of any one of the two backlight structures being not connected to the fault structure formed by connecting the second face and the emitting face of the other backlight structure.

10. A backlight structure comprising a plurality of backlight devices, each of the backlight devices comprising:
an emitting portion for providing a LED light source;
a reflection portion comprising an extending portion for mixing the light source provided by the emitting portion and a reflective face for reflecting the light uniformly mixed by the extending portion; and
a light-guiding portion for uniformly guiding the light mixed by the reflection portion, the light guiding portion comprising a first face and a second face opposite to the first face, the second face and the reflection portion connected to form a fault structure.

11. The backlight structure of claim 10, wherein the fault structure formed by the second face and the reflection portion of at least one of the backlight devices is joined with the first face of another backlight device.

12. The backlight structure of claim 11, wherein the reflection portion reflects the mixed light by 180 degrees to the light-guiding portion.

13. The backlight structure of claim 11, wherein the light-guiding portion is a light-guiding material with an oblique shape.

14. The backlight structure of claim 13, wherein the thickness of oblique shape decreases with the increase in incident distance of the light source.

15. The backlight structure of claim 11, wherein the light-guiding portion and the reflection portion are integrated to form one structure.

16. The backlight structure of claim 11, further comprising a passage formed by removing a section joining the second face of the light-guiding portion of one of the backlight devices and the first face of the light-guiding portion of another one of the backlight devices, such that light generated by the one of the backlight devices propagates to the another one of the backlight devices through this passage and vice versa.

17. The backlight structure of claim 11, wherein the fault structure is a stepped fault structure.

18. The backlight structure of claim 11, wherein the light-guiding portion comprises a light-guiding face connected with the reflection portion and a light output face opposite to the light-guiding face.

19. The backlight structure of claim 18, wherein a roughening process and a printing process are performed on the light-guiding face to form a scattering structure.

20. A backlight structure assembly, comprising a plurality of the backlight structures of claim 11, the first faces of two backlight structures being connected back to back to form a large-scale backlight area, the first face of any one of the two backlight structures being not connected to the fault structure formed by connecting the second face and the reflection face of the other backlight structure.
